(19) United States
(12) Patent Application Publication
(10) Pub. No.: US 2026/0342458 A1
(43) Pub. Date: Oct. 29, 2026

(54) METHOD AND DEVICE FOR LINE OF SIGHT (LOS) CLASSIFICATION IN WIRELESS COMMUNICATION

(71) Applicant: Samsung Electronics Co., Ltd., Gyeonggi-do (KR)

(72) Inventors: Junyoung CHOI, Gyeonggi-do (KR); Jinwook SEO, Gyeonggi-do (KR)

(21) Appl. No.: 19/659,446

(22) Filed: Apr. 27, 2026

(30) Foreign Application Priority Data
Apr. 28, 2025 (KR) 10-2025-0055380

(51) Int. Cl. H04B 17/309

(52) U.S. Cl. CPC H04B 17/309

(57) ABSTRACT

The disclosure relates to a 5G or 6G communication system for supporting a higher data transmission rate. A method for operating a first electronic device performing wireless communication includes performing a fine timing measurement (FTM) protocol with at least one second electronic device, obtaining a first input value for a signal transmitted or received through the FTM protocol, determining, using the first input value, whether the at least one signal transmitted to or received from the at least one second electronic device is a line of sight (LOS) signal, selecting, from among the at least one second electronic device, at least one third electronic device transmitting to or receiving from the first electronic device the at least one signal determined to be an LOS signal, and determining a position of the first electronic device using the at least one third electronic device.

### CROSS-REFERENCE TO RELATED APPLICATION(S)

This application is based on and claims priority under 35 U.S.C. § 119 to Korean Patent Application No. 10-2025-0055380, filed on Apr. 28, 2025, in the Korean Ministry of Intellectual Property (MOIP), the entire content of which is incorporated herein by reference.

### BACKGROUND

### 1. Field

The disclosure relates generally to the field of wireless communication, and more particularly, to an LOS classification method and device in wireless communication.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mm Wave) including 28 GHz and 39 GHz. In addition, it has been considered to implement 6G mobile communication technologies (referred to as Beyond 5G systems) in terahertz bands (for example, 95 GHz to 3 THz bands) to accomplish transmission rates fifty times faster than 5G mobile communication technologies and ultra-low latencies one-tenth of 5G mobile communication technologies.

At the beginning of the development of 5G mobile communication technologies, to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide an LOS classification method and device in which channel state information (CSI) reflects a signal-to-noise ratio (SNR) for each subcarrier for an orthogonal frequency division multiplexing (OFDM) symbol in a Wi-Fi environment, enabling the CSI to be used to determine whether the Wi-Fi signal is a LOS or non-LOS environment.

In accordance with an aspect of the disclosure, a method for operating a first electronic device performing wireless communication according to an embodiment of the disclosure may comprise performing a fine timing measurement (FTM) protocol with at least one second electronic device, obtaining a first input value for a signal transmitted or received through the FTM protocol, determining, using the first input value, whether the at least one signal transmitted to or received from the at least one second electronic device is an LOS signal, selecting, from among the at least one second electronic device, at least one third electronic device transmitting to or receiving from the first electronic device the at least one signal determined to be an LOS signal, and determining a position of the first electronic device using the at least one third electronic device.

In accordance with an aspect of the disclosure, a first electronic device performing wireless communication according to an embodiment of the disclosure may comprise a transceiver and a controller configured to perform an FTM protocol with at least one second electronic device, obtain a first input value for a signal transmitted or received through the FTM protocol, determine, using the first input value, whether the at least one signal transmitted to or received from the at least one second electronic device is an LOS signal, select, from among the at least one second electronic device, at least one third electronic device transmitting to or receiving from the first electronic device the at least one signal determined to be an LOS signal, and determine a position of the first electronic device using the at least one third electronic device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a short-range communication connection form of an electronic device according to an embodiment;

FIG. 2 illustrates operations of an access point (AP) and a station for establishing Wi-Fi access according to an embodiment;

FIG. 3 illustrates a wireless communication system including an AP and a wireless station according to an embodiment;

FIG. 4 illustrates a method for distinguishing signals according to an embodiment;

FIG. 5 illustrates a method for distinguishing signals according to an embodiment;

FIG. 6 illustrates an electronic device for distinguishing signals according to an embodiment;

FIG. 7 illustrates a method for obtaining an input value according to an embodiment;

FIG. 8 illustrates a method for obtaining an input value according to an embodiment;

FIG. 9 illustrates a method for obtaining an input value according to an embodiment;

FIG. 10 illustrates a structure of a first electronic device according to an embodiment; and

FIG. 11 illustrates a structure of a second electronic device according to an embodiment.

### DETAILED DESCRIPTION

Hereinafter, embodiments of the disclosure are described in detail with reference to the accompanying drawings.

In the drawings, the same or similar elements are preferably denoted by the same or similar reference numerals. Detailed descriptions of known functions or configurations that may cause the subject matter of the disclosure unclear will be omitted for the sake of clarity and conciseness.

For the same reasons, some elements may be exaggerated or schematically shown. The size of each element does not necessarily reflect the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto.

The components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

As used herein, each of the station (STA), the transmission device, the reception device, and the electronic device may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or by other terms. Each of the STA, the transmission device, the reception device, and the electronic device may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Each of the STA, the transmission device, the reception device, and the electronic device may include a machine to machine (M2M) terminal and a machine-type communication (MTC) terminal/device but the disclosure is not limited thereto. Herein, each of the STA, the transmission device, the reception device, and the electronic device may be simply referred to as a device.

Herein, wireless local area network (WLAN) and Wi-Fi may be used interchangeably. Although the disclosure describes a WLAN system including at least one AP and at least one STA for convenience of description, embodiments of the disclosure are applicable to other WLAN systems including, e.g., a plurality of WLANs, peer-to-peer (or independent basic service set) systems, Wi-Fi Direct systems, and/or hot spots.

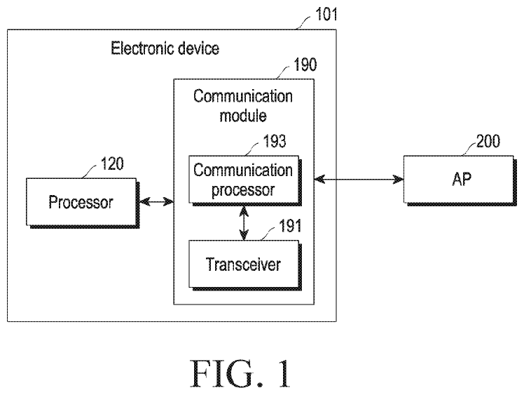

FIG. 1 illustrates a short-range communication connection form of an electronic device according to an embodiment.

Referring to FIG. 1, an electronic device 101 may be connected to an AP 200 based on Wi-Fi communication. The electronic device 101 may include a processor 120 and a communication module 190.

The communication module 190 may receive a signal from the outside or transmit a signal to the outside based on a Wi-Fi communication method known in the art.

The communication module 190 may include a transceiver 191 and a communication processor 193 or a short-range wireless communication module (e.g., Wi-Fi chipset)) for data transmission and reception with an external device. The communication module 190 may further include memory.

The transceiver 191 may convert a baseband transmission signal into a wireless signal or convert the received wireless signal into a baseband reception signal.

The communication module 190 may further include components for OFDM or orthogonal frequency division multiple access (OFDMA), e.g., a modulator, a digital-analog (D/A) converter, a frequency converter, an A/D converter, an amplifier, and/or a demodulator, in addition to the transceiver 191 and the communication processor 193.

The electronic device may include at least one antenna module that is electrically connected with the communication module of the AP 200 and supports the communication protocol and/or frequency band supported by the communication module of the AP 200.

The communication processor 193 may control the transceiver 191 to form a communication connection with the AP 200. For example, the communication connection may include a Wi-Fi network known in the art, or the communication processor 193 may control the transceiver 191 to form a radio connection with the AP 200 using WLAN standards known in the art.

The scheme of performing communication using the WLAN standards between the electronic device 101 and the AP 200 may be referred to as a communication scheme based on STA mode.

The processor 120 may include an application processor. The processor 120 may perform a designated operation of the electronic device 101 or control another piece of hardware (e.g., the communication module 190) to perform a designated operation.

The AP 200 may support the operation of transmitting data to an external network and/or receiving data from the external network by a plurality of electronic devices based on connection between the plurality of electronic devices (e.g., the electronic device 101) and the external network (e.g., Internet, external LAN, or cellular network).

The AP 200 may be a wireless router. The AP 200 may be a dedicated wireless router or a general-purpose device supporting mobile hotspot, but is not limited in implementation. For example, the AP 200 may include the same components as the electronic device 101.

The AP 200 may transmit/receive data to/from an external device, such as a server or the electronic device 101. For example, the AP 200 may transmit at least part of the data received from a server to the electronic device 101. The AP 200 and the electronic device 101 may transmit/receive uplink (UL)/downlink (DL) data during an operation period. For example, the AP 200 may transmit traffic to the electronic device 101 only during an operation period set based on the schedule information received from the electronic device 101.

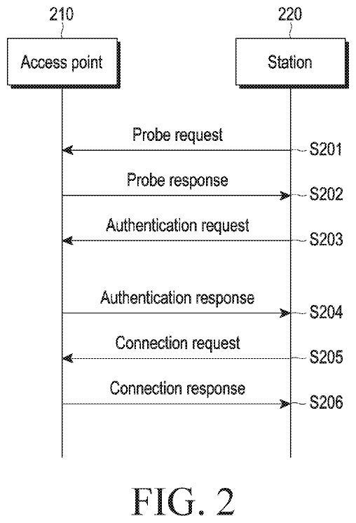

FIG. 2 illustrates operations of an AP and a station for establishing Wi-Fi access according to an embodiment.

Referring to FIG. 2, the AP 210 may be implemented as the AP 200 of FIG. 1 and may communicate with the STA 220 based on Wi-Fi. The STA 220 may be implemented as the electronic device 101 of FIG. 1. The STA 220 may be a UE having a Wi-Fi interface that supports Wi-Fi communication according to the relevant standard.

The STA 220 may transmit (or broadcast) a probe request message to the AP 210 (S201). The probe request message may be a message for the STA 220 to search for the peripheral AP 210. The probe request message may include information about at least one communication capability supported by the STA 220. The STA 220 may receive a beacon message from the AP 210 and transmit a probe request message to the AP 210 based on the information included in the beacon message. The AP 210 may transmit a probe response message in response to the probe request message (S202).

Upon receiving the probe response message, the STA 220 may transmit an authentication request message to the AP 210 (S203). The AP 210 transmits an authentication response message to the STA 220 in response to the authentication request message (S204), and an authentication procedure between the AP 210 and the STA 220 may be completed. The authentication procedure of S203 and S204 may be a process of performing authentication by selecting a channel having the strongest reception strength from among messages received during a channel search process. The STA 220 and the AP 210 may negotiate an encryption method of the authentication procedure through the authentication procedure of S203 and S204.

When the authentication procedure is completed, the STA 220 may transmit a connection request message (association request) to the AP 210 to perform connection establishment for the AP 210 (S205). The connection request message may include information about at least one capability to be used for data communication between the STA 220 and the AP 210 according to the relevant standard. The AP 210 may generate an association ID (AID) for the STA 220 and transmit a connection response message (association response) to the STA 220 (S206).

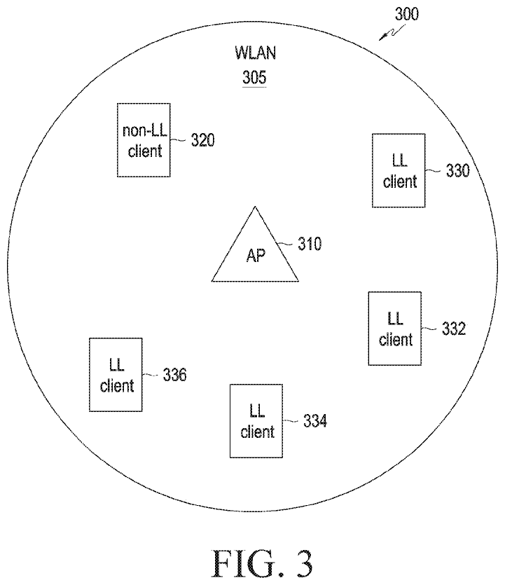

FIG. 3 illustrates a wireless communication system including an AP and a station according to an embodiment.

Referring to FIG. 3, the wireless communication system 300 may include a WLAN 305 including APs 310 and client electronic devices 320, 330, 332, 334, and 336 corresponding to stations.

The AP 310 may form a wireless communication channel or link with one or more STAs 320, 330, 332, 334, and 336. A unique media access control (MAC) address may be allocated to the AP 310.

The WLAN 305 is illustrated as an infrastructure basic service set (BSS), but may also be implemented as an independent basic service set (IBSS) network, or a peer-to-peer (P2P) network (e.g., operating according to Wi-Fi Direct protocols).

The STA (any one of 320, 330, 332, 334, and 336) may be any suitable Wi-Fi-enabled wireless device or electronic device, including, e.g., a cell phone, a PDA, a tablet device, a laptop computer, or the like. The STA (any one of 320, 330, 332, 334, and 336) may be referred to as a UE, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, an electronic device, or any other suitable term.

Referring to FIG. 3, the STAs 320, 330, 332, 334, and 336 may include an electronic device 320 that is a non-LL (legacy) client not requiring low-latency (LL) transmission and four electronic devices 330, 332, 334, and 336 that require LL transmission. Traffic from the wireless stations 330, 332, 334, and 336 requiring the LL requires a constant traffic speed, and may require, e.g., data transmission of 1500 bytes per 40 mm. The four LL client electronic devices may include electronic devices that require LL transmission and thus require transmission through preemption or electronic devices that require high-priority transmission.

The STAs 330, 332, 334, and 336 corresponding to the UL client connected to the AP 310 may use a point coordination function (PCF) transmission method and/or a distributed coordination function (DCF) transmission method for data transmission.

The PCF) transmission method involves the AP directly inquiring the plurality of stations and waiting for data transmission.

The DCF transmission method involves waiting after detection to avoid collisions before the STA transmits data in an environment in which the plurality of stations compete to transmit data.

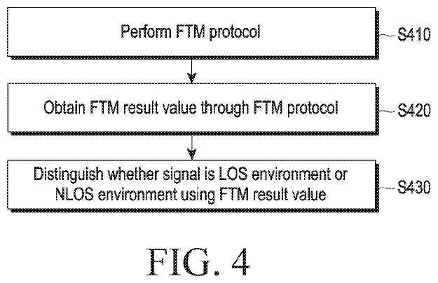

FIG. 4 illustrates a method for distinguishing signals according to an embodiment.

Referring to FIG. 4, at least one of a UE, the BS, and an electronic device may use a method for distinguishing or classifying signals including distinguishing or classifying at least one signal transmitted/received by at least one of the UE, the BS, or the electronic device into an LOS environment or a non-line of sight (NLOS) environment. When at least one of the UE, the BS, or the electronic device is an LOS environment, the position may be specified using at least one signal corresponding to the LOS environment.

At least one of the UE, the BS, or the electronic device may use CSI to distinguish or classify signals. The CSI may be referred to as channel status information. The CSI may include SNR information for each subcarrier for the OFDM symbol in a Wi-Fi environment. Therefore, the CSI may be used to determine whether the Wi-Fi signal is an LOS environment or an NLOS environment. In other words, the CSI may be used as a condition for determining whether the transmitted/received signal is an LOS environment or an NLOS environment.

At least one of the UE, the BS, or the electronic device may distinguish or classify signals without using the 678. At least one of the UE, the BS, or the electronic device may distinguish or classify signals using at least one of a Wi-Fi characteristic or a positioning characteristic instead of CSI.

The Wi-Fi characteristics may include characteristics using the Wi-Fi FTM protocol or received signal strength indicator (RSSI) characteristics through channel modeling.

Referring to FIG. 4, in step S410, at least one of the UE, the BS, or the electronic device may perform the Wi-Fi FTM protocol. In step S420, at least one of the UE, the BS, or the electronic device may obtain information about the position using the Wi-Fi FTM protocol, by obtaining an FTM result value for the position using the Wi-Fi FTM protocol. At least one of the UE, the BS, or the electronic device may obtain at least one of a distance value, RSSI, and a standard deviation value for the AP using the FTM result value.

In step S430, at least one of the UE, the BS, or the electronic device may distinguish or classify signals using a deviation for the FTM result value. At least one of the UE, the BS, or the electronic device may obtain an RSSI value through channel modeling. Signals may be distinguished or classified by utilizing the deviation of the RSSI value through channel modeling.

The positioning characteristics may include characteristics of using coordinates where the AP is deployed. At least one of the UE, the BS, or the electronic device may obtain the distance measured using the coordinates of the AP, may obtain an estimated distance, may distinguish or classify signals by comparing a difference between the measured distance and the estimated distance, and may determine whether the at least one signal is an LOS environment by a distance obtained using three-dimensional (3D) indoor map information based on the actually measured distance value with the surrounding APs and the currently estimated distance value.

At least one of the UE, the BS, or the electronic device may determine whether the at least one signal is an LOS environment or an NLOS environment, and may determine the quality of the at least one signal by determining the at least one signal. When at least one of the UE, the BS, or the electronic device determines that the transmitted/received signal is LOS, it may be determined that the quality of the at least one signal is high. At least one of the UE, the BS, or the electronic device may select an AP for use in localization using the quality of the transmitted/received signals.

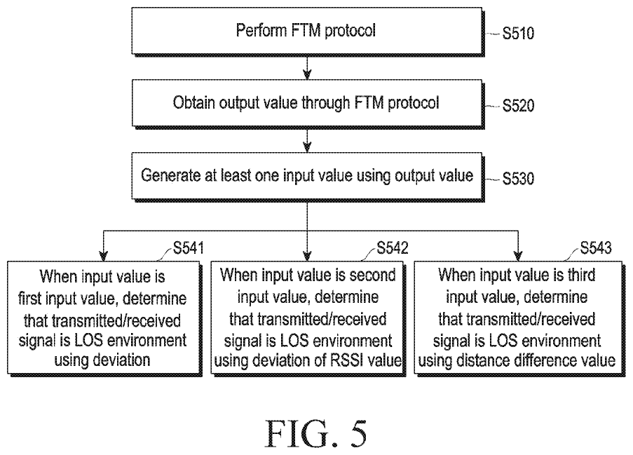

FIG. 5 illustrates a method for distinguishing signals according to an embodiment.

Referring to FIG. 5, in step S510, at least one of a UE, a BS, and an electronic device may perform an FTM protocol with an AP. The AP may include a peripheral AP of the UE, the BS, or the electronic device. In step S520, at least one of the UE, the BS, or the electronic device may perform an FTM protocol to obtain an output value (or an FTM result value). The output value obtained through the FTM protocol may include at least one of the distance with AP, deviation, or RSSI.

In step S530, at least one of the UE, the BS, or the electronic device may generate at least one input value through an output value obtained through the FTM protocol. The input value may include at least one of a first input value, a second input value, or a third input value. The first input value indicates the deviation of the FTM result value. The second input value is a value using the deviation of the RSSI value and may include a difference value between the measured RSSI and the estimated RSSI. The third input value may include the difference value between the measured distance and the estimated distance (measured distance-estimated distance).

A method for distinguishing or classifying signals through the first input value by the UE, the BS, or the electronic device may be referred to as a first signal classification method. The first signal classification method may include a method for distinguishing or classifying signals using the deviation of the FTM result value. The first input value may be represented as σₜ and may include the measured deviation. The measured deviation may include the standard deviation of individual FTM measurement values s in one FTM burst performed at a specific time t. The standard deviation (σ) may indicate how much the individual FTM measurement values are distributed from the average value.

In step S541, at least one of the UE, the BS, or the electronic device may determine that the probability of a signal being an LOS signal increases as the deviation in the burst decreases.

At least one of the UE, the BS, or the electronic device may control the first threshold to determine whether the transmitted/received signal is an LOS environment when the measured deviation is less than or equal to the first threshold.

A method for distinguishing or classifying signals through the second input value by the UE, the BS, or the electronic device may be referred to as a second signal classification method. The second signal classification method may include a method for distinguishing or classifying signals by utilizing the deviation of the RSSI value. The second input value may be represented as α_{i,t} and may include the difference value between the measured RSSI and the estimated RSSI (measured RSSI-estimated RSSI).

In step S542, at least one of the UE, the BS, or the electronic device may determine that the probability of the LOS signal increases as the difference value (measured RSSI−estimated RSSI) between the measured RSSI and the estimated RSSI decreases. α_{i,t} may be represented as shown below in Equation (1).

α_{i,t}=|r_{i,t}−\hat{r}_{i,t}| (1)

In Equation (1), r_{i,t} indicates the RSSI measured between the ith AP and the electronic device at time t while performing the FTM protocol. The electronic device may include at least one of the UE or the BS. \hat{r}_{i,t} indicates the RSSI estimated based on the distance d_{i,t-1} from the ith AP at time t using the pathloss channel model. The pathloss channel model may include a WINNER II indoor office model. At least one of the channel model or the pathloss channel model may have a different coefficient according to the environment. At least one of the electronic device, the UE, or the BS may adjust the channel model or the pathloss channel model to suit the environment. d_{i,t-1} indicates the distance measured between the ith AP and the electronic device at time t−1 while performing the FTM protocol.

A method for distinguishing or classifying signals through the third input value by at least one of the UE, the BS, or the electronic device may be referred to as a third signal classification method. The third signal classification method may include a method for distinguishing or classifying signals using a distance and may be represented as β_{i,t}. The third input value may include the difference value between the measured distance and the estimated distance (measured distance-estimated distance). At least one of the UE, the BS, or the electronic device may determine that the probability of being LOS is higher as the difference value between the measured distance and the estimated distance (measured distance−estimated distance) is smaller (S543). β_{i,t} may be represented as shown below in Equation (2).

β_{i,t}=|d_{i,t}−\hat{d}_{i,t-1}| (2)

In Equation (2), d_{i,t} indicates the distance measured between the ith AP and the electronic device at time t while performing the FTM protocol. \hat{d}_{i,t} indicates an estimated distance between the ith AP and the electronic device at time t using the position of the electronic device and the position of the ith AP. The position of the electronic device may include the position at time t−1. The position of the electronic device at time t−1 may be represented as (xₜ₋₁, yₜ₋₁, zₜ₋₁). The position of the ith AP may be represented as (xᵢ, yᵢ, zᵢ). \hat{d}_{i,t-1} indicates the estimated distance between the ith AP and the electronic device at time t−1 using the position of the electronic device and the position of the ith AP. \hat{d}_{i,t-1} may be represented as shown below in Equation (3).

\hat{d}_{i,t-1}=\sqrt{(xₜ₋₁−xᵢ)²+(yₜ₋₁−yᵢ)²+(zₜ₋₁−zᵢ)²} (3)

In Equation (3), (xₜ₋₁, yₜ₋₁, zₜ₋₁) may indicate the position of the electronic device at time t−1. (xᵢ, yᵢ, zᵢ) may indicate the position of the ith AP.

The reason for not using d_{i,t} is that if it is determined that the at least one signal with the AP is NLOS, using the distance information about the NLOS signal may be a factor in decreasing accuracy. The reason for not using d_{i,t} is that FTM is not performed with all the APs, and the longer the time difference between FTMs, the greater the distance will be, so it may be difficult to use as an accurate classification criterion. The reason for not using d_{i,t} is that when calculating the position with triangulation and measuring the distance from the AP, it is necessary to calculate based on the most recent position.

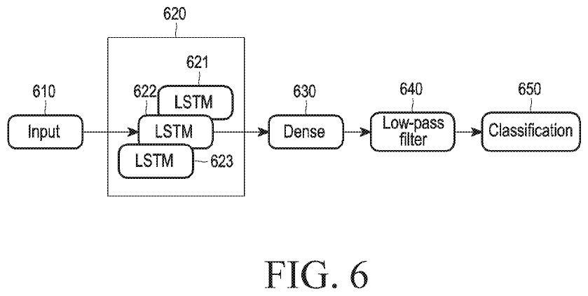

FIG. 6 illustrates an electronic device for distinguishing signals according to an embodiment.

At least one of the UE, the BS, or the electronic device may generate an input value and may include at least one of an input unit (input), an LSTM, a dense layer (dense), a low-pass filter, or a classification unit (classification). The input unit 610 may receive the input value. The input value may include at least one of a first input value, a second input value, or a third input value and indicates the deviation of the FTM result value. The second input value uses the deviation of the RSSI value and may include a difference value between the measured RSSI and the estimated RSSI. The third input value may include the difference value between the measured distance and the estimated distance (measured distance−estimated distance).

At least one of the UE, the BS, or the electronic device may use at least one of the first signal classification method, the second signal classification method, or the third signal classification method through the input value. The first signal classification method may include a method for distinguishing or classifying signals using the deviation of the FTM result value. The second signal classification method may include a method for distinguishing or classifying signals by utilizing the deviation of the RSSI value. The third signal classification method may include a method for distinguishing or classifying signals using a difference value between the measured distance and the estimated distance.

At least one of the UE, the BS, or the electronic device may transmit the input value as input data of an LOS classification model (120). The LOS classification model may include at least one of an AI model, an ML model, or an algorithm. The LOS classification model may include at least one of a recurrent neural network (RNN) or a long short-term memory model (LSTM). The LSTM may be a type of RNN that may capably handle long-term dependency and may maintain important information and discard unnecessary information.

The LOS classification model 620 may perform one-hot encoding through the input value. The LOS classification model may perform one-hot encoding using input data. The LOS classification model may include at least one LSTM. The LOS classification model 620 may process the input data using at least one LSTM. For example, the LOS classification model 620 may process the first input value through the first LSTM 621, the second input value through the second LSTM 622, and the third input value through the third LSTM 623. The first LSTM 621 may use the first signal classification method and may perform a method for distinguishing or classifying signals using the deviation of the FTM result value. The second LSTM 622 may use the second signal classification method and may use a method for distinguishing or classifying signals by utilizing the deviation of the RSSI value. The third LSTM 623 may use the third signal classification method and may perform a method for distinguishing or classifying signals using the difference value between the measured distance and the estimated distance.

The LOS classification model may include a dense layer (or dense) 630. The dense layer may process the data processed by at least one LSTM and may calculate an output value using a weight and a bias (130).

The LOS classification model may include a low-pass filter 640 which is used in signal processing. The low-pass filter may transmit low-frequency signals and block high-frequency signals and may be used for smoothing or noise filtering of signals in the time domain.

The LOS classification model may be signal classification unit (classification) 650. At least one of the UE, the BS, or the electronic device may convert the output value of the LSTM into a value between 0 and 1. In other words, at least one of the UE, the BS, or the electronic device may convert the output value of the LSTM into a value between 0 and 1 using a function. The function may include a sigmoid activation function. At least one of the UE, the BS, or the electronic device may convert at least one of the output value of the LSTM, the dense layer, and the low-pass filter into a value between 0 and 1 using the function.

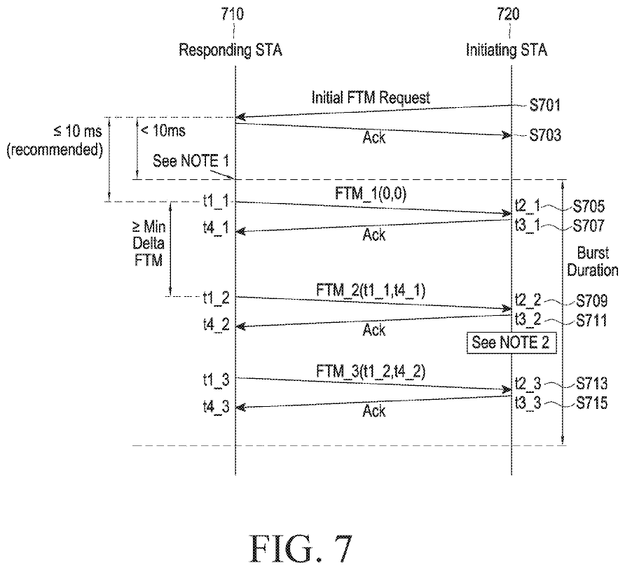

At least one of the UE, the BS, or the electronic device may output a classification result of whether a signal transmitted/received through the converted value is a LOS environment or a NLOS environment. The first signal classification method may be as illustrated in FIG. 7.

FIG. 7 illustrates a method for obtaining an input value according to an embodiment.

Referring to FIG. 7, the input value indicates the first input value. The first input value indicates the deviation of the FTM result value. The first input value may include the standard deviation of the burst during the FTM at time t. The initiating STA 720, which initiates communication, may transmit an initial FTM request message to at least one responding STA 710 (S701). The responding STA performs communication with the initiating STA. The STA may include the initiating STA or the responding STA and at least one of a UE or an electronic device. The initiating STA 720 distinguishes whether the transmitted/received signal is a NOS environment and selects an STA having good signal quality for distinguishing whether the transmitted/received signal is a NOS environment. At least one responding STA 710 may include at least one of the UE or the electronic device. The at least one responding STA may include at least one of the UE or the electronic device.

The at least one responding STA 710 may transmit a response message to the initial FTM request message to the initiating STA 720 (S703).

The initiating STA 720 may determine the start time of the burst duration within 10 milliseconds (ms) immediately after the responding STA receives the initial FTM request message.

The responding STA 710 may determine a timing synchronization function (TSF) timer in 10 ms immediately after receiving the initial FTM request message. The TSF timer time and the burst start time may be the same.

The responding STA 710 may transmit a signal for FTM_1(0,0) to the initiating STA 720 (S705) within a time equal to or less than 10 ms immediately after receiving the initial FTM request message. The time when the responding STA 710 transmits the at least one signal for FTM may be referred to as t1_1. Time t1_1 may refer to when the responding STA transmits a signal for a first FTM. The initiating STA 720 may receive the at least one signal for FTM_1(0,0) from the responding STA 710.

The time when the initiating STA 720 receives the at least one signal for FTM may be t2_1. Time t2_1 indicates a time when the initiating STA 720 receives the at least one signal for the first FTM transmitted by the responding STA 710. The initiating STA 720 may transmit a response message to the at least one signal for FTM to the responding STA 710 (S707). The initiating STA 720 may transmit a response message to the at least one signal for FTM_1(0,0) to the responding STA 710. The initiating STA 720 may transmit a response message to the at least one signal for FTM to the responding STA 710 at time t3_1. Time t3_1 indicates a time when the initiating STA transmits a response message to the at least one signal for the first FTM to the responding STA 710.

The responding STA 710 may receive a response message to the at least one signal for FTM_1(0,0) from the initiating STA 720. The time when the responding STA 710 receives a response message to the at least one signal for FTM may be t4_1. Time T4_1 indicates a time when the responding STA 710 receives a response message to the at least one signal for the first FTM transmitted by the initiating STA 720.

The responding STA 710 may transmit the at least one signal for FTM_2(t1_1,t4_1) to the initiating STA 720 (S709). The time when the responding STA 710 transmits the at least one signal for FTM may be referred to as t1_2. Time t1_2 may refer to a time when the responding STA transmits the at least one signal for FTM for a second time. Time t1_2 indicates a time within a threshold from t1_1 as the start time. The threshold may include the minimum change FTM (min delta FTM). The threshold indicates a preset value. The initiating STA 720 may receive the at least one signal for FTM from the responding STA 710. The initiating STA 720 may receive the at least one signal for FTM_2(t1_1,t4_1) from the responding STA 710.

The time when the initiating STA 720 receives the at least one signal for FTM may be t2_2. Time t2_2 indicates a time when the initiating STA 720 receives the at least one signal for the second FTM transmitted by the responding STA. The initiating STA 720 may transmit a response message to the at least one signal for FTM to the responding STA 710 (S711). The initiating STA 720 may transmit a response message to the at least one signal for FTM_2(t1_1,t4_1) to the responding STA. The initiating STA 720 may transmit a response message to the at least one signal for FTM to the responding STA 710 at time t3_2. Time t3_2 indicates a time when the initiating STA 720 transmits a response message to the at least one signal for the second FTM to the responding STA 710.

The responding STA 710 may receive a response message to the at least one signal for FTM_2(t1_1,t4_1) from the initiating STA 720. The time when the responding STA 710 receives a response message to the at least one signal for FTM may be t4_2. Time T4_2 indicates a time when the responding STA receives a response message to the at least one signal for the second FTM transmitted by the initiating STA.

The initiating STA 720 may calculate at least one of a round trip time (RTT) and a clock offset estimate.

The responding STA 710 may transmit the at least one signal for FTM_3(t1_2, t4_2) to the initiating STA 720 (S713). The time when the responding STA 710 transmits the at least one signal for FTM may be referred to as t1_3. Time t1_3 may refer to a time when the responding STA 710 transmits a signal for the third FTM. Time t1_3 indicates a time within a threshold from t1_2 as the start time. The threshold may include the minimum change FTM (min delta FTM). The threshold indicates a preset value. The initiating STA may receive the at least one signal for FTM from the responding STA 710. The initiating STA 720 may receive the at least one signal for FTM_3(t1_2, t4_2) from the responding STA 710.

The time when the initiating STA 720 receives the at least one signal for FTM may be t2_3. Time t2_3 indicates a time when the initiating STA 720 receives the at least one signal for the third FTM transmitted by the responding STA 710. The initiating STA 720 may transmit a response message to the at least one signal for FTM_3(t1_2, t4_2) to the responding STA 710 (S715). The initiating STA 720 may transmit a response message to the at least one signal for FTM to the responding STA 710 at time t3_3. Time t3_3 indicates a time when the initiating STA transmits a response message to the at least one signal for the third FTM to the responding STA 710.

The responding STA 710 may receive a response message to the at least one signal for FTM_3(t1_2, t4_2) from the initiating STA 720. The time when the responding STA 710 receives a response message to the at least one signal for FTM may be t4_3. Time T4_3 indicates a time when the responding STA 710 receives a response message for the third FTM transmitted by the initiating STA.

For example, the initiating STA 720 may perform the FTM protocol with 15 APs. In other words, the initiating STA 720 may perform the FTM protocol with 15 responding STAs. When the initiating STA 720 successfully performs the FTM protocol with 11 APs out of 15 APs, it may form 8 bursts per FTM. The total time required for performing 15 FTMs may be 1710 ms. The average time required for FTM performed by the initiating STA 720 may be 111 ms. The standard deviation for the FTM performed by the initiating STA 720 may be 46 ms.

The initiating STA 720 may require three APs at two-dimensional (2D) positioning. The average FTM time required for the initiating STA 720 and three APs may be 332 ms. The number of times in which positioning is possible per second of the initiating STA 720 may be 3.

The initiating STA 720 may determine whether the at least one signal transmitted/received with the responding STA is a NOS using at least one of the average time required or the standard deviation. When at least one of the average time required or the standard deviation is less than or equal to a threshold, the initiating STA 720 may determine whether the at least one signal transmitted/received with the responding STA 710 is NOS. The threshold may include any set value.

At least one of the UE, the BS, or the electronic device may use the second signal classification method to determine whether the transmitted/received signal is NOS.

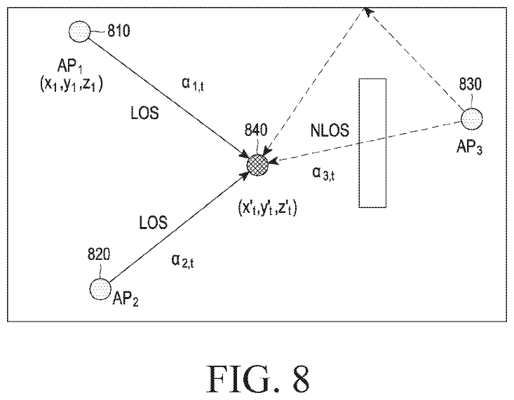

FIG. 8 illustrates a method for obtaining an input value according to an embodiment.

Referring to FIG. 8, the input value indicates the second input value which may be determined in Equation (1) representing the difference value (measured RSSI-estimated RSSI) between the measured RSSI and the estimated RSSI. At least one of the UE, the BS, or the electronic device may obtain the deployment information about the AP to calculate the second input value. The deployment information about the AP may include at least one of position information about the AP, channel and frequency band of the AP, capability of the AP, or signal strength of the AP. The deployment information about the AP may include position information about the AP in the building. The position information about the AP may be represented as (xᵢ, yᵢ, zᵢ).

At least one of the UE, the BS, or the electronic device may include an indoor pathloss model, may calculate the estimated RSSI, may calculate a RSSI estimated through the measured distance value or the estimated distance value, and may calculate the estimated RSSI using an indoor pathloss model. The estimated RSSI may be represented as shown below in Equation (4).

$${\hat{r}}_{i , t} = TXpower - {PL}_{i , t} = TXpower - A \cdot {log}_{10} {\hat{d}}_{i , t} + B + C \cdot {log}_{10} ( \frac{{f}_{c} ( GHz )}{5.0} ) + X \qquad ( 4 )$$

In Equation (4), \hat{r}_{i,t} indicates the estimated RSSI value. In other words, \hat{r}_{i,t} indicates the estimated RSSI value for the ith AP at time t. TXpower indicates the power of the transmitted signal. At least one of A, B, or C may be an integer value. At least one of A, B, or C each may be set by factors causing a pathloss (PL).

At least one of A, B, or C indicates a coefficient of each element causing pathloss. At least one of A, B, or C may be set to a different value according to an environment (indoor office, indicator mall, outdoor, etc.). For example, at least one of A, B, or C indicates a coefficient according to an environment such as an indoor office, an indoor mall, or outdoor. X indicates noise. X may be used as a Gaussian random variable. X may be used as a factor that gives randomness of modeling. PL_{i,t} indicates the pathloss for the ith AP at time t. PL may indicate the level (dB scale) of the at least one signal attenuated according to the distance when the at least one signal is transmitted in a free space or air. PL may be represented as shown below in Equation (5).

$$P L = A \cdot {log}_{10} d ( m ) + B + C \cdot {log}_{10} ( \frac{{f}_{c} ( GHz )}{5.0} ) + X \qquad ( 5 )$$

In Equation (5), at least one of A, B, or C indicates a coefficient of each element causing pathloss. At least one of A, B, or C may be set to a different value according to an environment (indoor office, indicator mall, outdoor, etc.). For example, at least one of A, B, or C indicates a coefficient according to an environment such as an indoor office, an indoor mall, or outdoor. X indicates noise. X may be used as a Gaussian random variable. X may be used as a factor that gives randomness of modeling. PL_{i,t} indicates the pathloss for the ith AP at time t. PL may indicate the level (dB scale) of the at least one signal attenuated according to the distance when the at least one signal is transmitted in a free space or air.

Referring to FIG. 8, the AP1 810 and the AP2 820 may correspond to the LOS in relation to the electronic device 840. The AP3 830 may correspond to the NLOS in relation to the electronic device 840. Accordingly, alt for the AP1 810 may have a value less than α_{3,t} for the AP3 830. α_{2,t} for the AP2 820 may have a lower value than @3,t for the AP3 830. It may be expected that α_{3,t} for the AP3 830 is a relatively high value; that is, α_{3,t} for the AP3 830 may have a value of at least 10 dB.

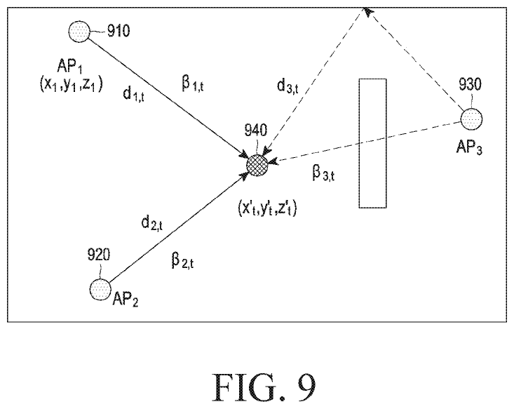

At least one of the UE, the BS, or the electronic device may use the third signal classification method to determine whether the transmitted/received signal is NOS. The third signal classification method may be as illustrated in FIG. 9. FIG. 9 relates to a method for distinguishing or classifying signals using a distance.

FIG. 9 illustrates a method for obtaining an input value according to an embodiment.

Referring to FIG. 9, the input value may refer to the third input value which is determined in Equation (2). At least one of the UE, the BS, or the electronic device may obtain the deployment information about the AP to calculate the third input value. The deployment information about the AP may include at least one of position information about the AP, channel and frequency band of the AP, capability of the AP, or signal strength of the AP. The deployment information about the AP may include position information about the AP in the building. The position information about the AP may be represented as (xᵢ, yᵢ, zᵢ). The third input value may be calculated using at least one of d_{i,t} or \hat{d}_{i,t-1}. d_{i,t} may include the distance value obtained by FTM. d_{i,t} may include distance information measured by the FTM protocol. \hat{d}_{i,t-1} may be determined in Equation (3).

For example, in FIG. 9, the AP1 910 and the AP2 920 may correspond to the LOS in relation to the electronic device 940. The AP3 930 may correspond to the NLOS in relation to the electronic device 940. Accordingly, β_{1,t} for the AP1 910 may have a lower value than β_{3,t} for the AP3 930. β_{2,t} for the AP2 920 may have a lower value than β_{3,t} for the AP3 930. It may be expected that β_{3,t} for the AP3 930 is a relatively high value greater than β_{1,t} or β_{2,t}.

At least one of the UE, the BS, or the electronic device may use at least one of the first signal classification method, the second signal classification method, or the third signal classification method. In other words, at least one of the UE, the BS, or the electronic device may use the first signal classification method, the second signal classification method, and the third signal classification method together.

The at least one signal classification method of FIGS. 7 to 9 may be used together with FIG. 6. For example, at least one of the UE, BS, or electronic device may perform the operations of FIG. 6 after calculating the input values of FIGS. 7 to 9 by performing the FTM protocol. The order of FIGS. 7 to 9 is not limited to the embodiment.

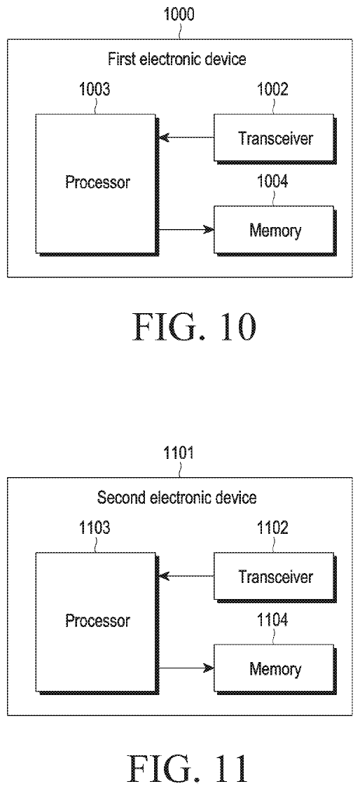

FIG. 10 illustrates a structure of a first electronic device according to an embodiment. The first electronic device of FIG. 10 may be implemented as at least one of the BS, the UE, or the electronic device illustrated in FIGS. 1 to 9.

Referring to FIG. 10, the first electronic device 1001 may include a transceiver 1002, a processor 1003, and memory 1004. The first electronic device 1001 may include at least one of a electronic device, a server, a UE, a terminal, a network entity, an AP, an initiating STA, a responding STA, and a BS. In the disclosure, the controller may be defined as a circuit, an application-specific integrated circuit, or at least one processor.

The transceiver 1002 may transmit/receive signals to/from an external electronic device.

The processor 1003 may control the overall operation of the electronic device according to an embodiment proposed in the disclosure. For example, the processor 1003 may control the at least one signal flow between each block to perform the operation according to the flowchart described above. Specifically, the processor 1003 may control, e.g., the operation of the first electronic device illustrated in FIGS. 1 to 9.

The memory 1004 may store at least one of the information transmitted/received through the transceiver 1002 and information generated through the processor 1003.

FIG. 11 illustrates a structure of a second electronic device according to an embodiment. The second electronic device of FIG. 11 may be implemented as at least one of the UE, the electronic device, or the BS illustrated in FIGS. 1 to 9.

Referring to FIG. 11, the second electronic device 1101 may include a transceiver 1102, a processor 1103, and memory 1104. The second electronic device 1101 may include at least one of an electronic device, a server, a UE, a terminal, a network entity, an AP, an initiating STA, a responding STA, and a BS. In the disclosure, the processor may be defined as a circuit, an application-specific integrated circuit, or at least one processor.

The transceiver 1102 may transmit/receive signals to/from an external electronic device.

The processor 1103 may control the overall operation of the electronic device according to an embodiment proposed in the disclosure. For example, the processor 1103 may control the at least one signal flow between each block to perform the operation according to the flowchart described above. Specifically, the processor 1103 may control, e.g., the BS or the electronic device illustrated in FIGS. 1 to 9.

The memory 1104 may store at least one of the information transmitted/received through the transceiver 1102 and information generated through the processor 1120.

It is noted that the views illustrated in FIGS. 1 to 11 are not intended to limit the scope of the disclosure, such that all the configurations or operations illustrated in FIGS. 1 to 11 should not be construed as essential components to practice the disclosure.

As described above, a method for operating a first electronic device performing wireless communication may include performing an FTM protocol with at least one second electronic device, obtaining a first input value for a signal transmitted and received through the FTM protocol, determining, using the first input value, whether the at least one signal transmitted and received with the at least one second electronic device is an LOS signal, selecting at least one third electronic device from among the at least one second electronic device having a signal transmitted and received by the first electronic device which is an LOS signal, and determining a position of the first electronic device using the at least one third electronic device.

The first input value may include at least one of a standard deviation value measured for the FTM, an RSSI value measured for the FTM, and a distance value measured for the second electronic device. Determining, using the first input value, whether the at least one signal transmitted and received with the at least one second electronic device is the LOS signal may include determining whether the standard deviation value is less than or equal to a set threshold, when the standard deviation value is less than or equal to the set threshold, determining that the at least one signal for the at least one second electronic device is the LOS signal, and when the standard deviation value exceeds the set threshold, determining that the at least one signal for the at least one second electronic device is an NLOS signal.

Determining, using the first input value, whether the at least one signal transmitted and received with the at least one second electronic device is the LOS signal may include obtaining an estimated RSSI for the at least one signal, determining whether a difference between the measured RSSI and the estimated RSSI is less than or equal to a threshold, when the difference is less than or equal to the threshold, determining that the at least one signal for the at least one second electronic device is the LOS signal, and when the difference exceeds the threshold, determining that the at least one signal for the at least one second electronic device is an NLOS signal.

The estimated RSSI may be estimated using a pathloss model.

Determining, using the first input value, whether the at least one signal transmitted and received with the at least one second electronic device is the LOS signal may include obtaining an estimated distance value for the at least one signal, determining whether a difference between the measured distance value and the estimated distance value is less than or equal to a threshold, when the difference is less than or equal to the threshold, determining that the at least one signal for the at least one second electronic device is the LOS signal, and when the difference exceeds the threshold, determining that the at least one signal for the at least one second electronic device is an NLOS signal.

Determining, using the first input value, whether the at least one signal transmitted and received with the at least one second electronic device is the LOS signal may include determining whether the at least one signal transmitted and received with the at least one second electronic device is the LOS signal using an output value of a model using the first input value as input data. The model may be an LOS classification model.

The model may include at least one of an AI model including a recurrent neural network (RNN) model and a long short-term memory model (LSTM), a machine learning (ML) model including the RNN model and the LSTM, and an algorithm model including the RNN model and the LSTM.

A first electronic device performing wireless communication may comprise a transceiver and a controller configured to perform an FTM protocol with at least one second electronic device, obtain a first input value for a signal transmitted and received through the FTM protocol, determine, using the first input value, whether the at least one signal transmitted and received with the at least one second electronic device is an LOS signal, select at least one third electronic device from among the at least one second electronic device having a signal transmitted and received by the first electronic device which is an LOS signal, and determine a position of the first electronic device using the at least one third electronic device.

The first input value may include at least one of a standard deviation value measured for the FTM, an RSSI value measured for the FTM, and a distance value measured for the second electronic device.

When determining, using the first input value, whether the at least one signal transmitted and received with the at least one second electronic device is the LOS signal, the controller may be further configured to determine whether the standard deviation value is less than or equal to a set threshold, when the standard deviation value is less than or equal to the set threshold, determine that the at least one signal for the at least one second electronic device is the LOS signal, and when the standard deviation value exceeds the set threshold, determine that the at least one signal for the at least one second electronic device is an NLOS signal.

When determining, using the first input value, whether the at least one signal transmitted and received with the at least one second electronic device is the LOS signal, the controller may be further configured to obtain an estimated RSSI for the at least one signal, determine whether a difference between the measured RSSI and the estimated RSSI is less than or equal to a threshold, when the difference is less than or equal to the threshold, determine that the at least one signal for the at least one second electronic device is the LOS signal, and when the difference exceeds the threshold, determine that the at least one signal for the at least one second electronic device is an NLOS signal.

The estimated RSSI may be estimated using a pathloss model.

When determining, using the first input value, whether the at least one signal transmitted and received with the at least one second electronic device is the LOS signal, the controller may be configured to obtain an estimated distance value for the at least one signal, determine whether a difference between the measured distance value and the estimated distance value is less than or equal to a threshold, when the difference is less than or equal to the threshold, determine that the at least one signal for the at least one second electronic device is the LOS signal, and when the difference exceeds the threshold, determine that the at least one signal for the at least one second electronic device is an NLOS signal.

When determining, using the first input value, whether the at least one signal transmitted and received with the at least one second electronic device is the LOS signal, the controller may be configured to determine whether the at least one signal transmitted and received with the at least one second electronic device is the LOS signal using an output value of a model using the first input value as input data. The model may be an LOS classification model.

The model may include at least one of an AI model including an RNN model and an LSTM, an ML model including the RNN model and the LSTM, and an algorithm model including the RNN model and the LSTM.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” indicates a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. The components and ‘units’ may be implemented to execute one or more CPUs in a device or secure multimedia card. According to embodiments of the disclosure, a “ . . . unit” may include one or more processors.

The methods according to the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), WLAN, or storage area network (SAN) or a communication network configured of a combination thereof. The storage device may connect to the device that performs embodiments of the disclosure via an external port. A separate storage device over the communication network may be connected to the device that performs embodiments of the disclosure.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method for operating a first electronic device performing wireless communication, the method comprising:
performing a fine timing measurement (FTM) protocol with at least one second electronic device;
obtaining a first input value for at least one signal transmitted or received through the FTM protocol;
determining, using the first input value, whether the at least one signal transmitted to or received from the at least one second electronic device is a line of sight (LOS) signal;
selecting, from among the at least one second electronic device, at least one third electronic device transmitting to or receiving from the first electronic device the at least one signal determined to be an LOS signal; and
determining a position of the first electronic device using the at least one third electronic device.

2. The method of claim 1,
wherein the first input value includes at least one of a standard deviation value measured for the FTM, a measured received signal strength indicator (RSSI) value for the FTM, or a distance value measured for the at least one second electronic device.

3. The method of claim 2, wherein determining, using the first input value, whether the at least one signal transmitted to or received from the at least one second electronic device is an LOS signal includes:
determining whether the standard deviation value is less than or equal to a set threshold;
when the standard deviation value is less than or equal to the set threshold, determining that the at least one signal for the at least one second electronic device is an LOS signal; and
when the standard deviation value exceeds the set threshold, determining that the at least one signal for the at least one second electronic device is a non-line of sight (NLOS) signal.

4. The method of claim 2, wherein determining, using the first input value, whether the at least one signal transmitted to or received from the at least one second electronic device is an LOS signal includes:
obtaining an estimated RSSI for the at least one signal;
determining whether a difference between the measured RSSI and the estimated RSSI is less than or equal to a threshold;
when the difference is less than or equal to the threshold, determining that the at least one signal for the at least one second electronic device is an LOS signal; and
when the difference exceeds the threshold, determining that the at least one signal for the at least one second electronic device is an NLOS signal.

5. The method of claim 4, wherein the estimated RSSI is estimated using a pathloss model.

6. The method of claim 2, wherein determining, using the first input value, whether the at least one signal transmitted to or received from the at least one second electronic device is an LOS signal includes:
obtaining an estimated distance value for the at least one signal;
determining whether a difference between the measured distance value and the estimated distance value is less than or equal to a threshold;
when the difference is less than or equal to the threshold, determining that the at least one signal for the at least one second electronic device is an LOS signal; and
when the difference exceeds the threshold, determining that the at least one signal for the at least one second electronic device is an NLOS signal.

7. The method of claim 1,
wherein determining, using the first input value, whether the at least one signal transmitted to or received from the at least one second electronic device is an LOS signal includes determining whether the at least one signal transmitted to or received from the at least one second electronic device is an LOS signal using an output value of a model using the first input value as input data, and
wherein the model is an LOS classification model.

8. The method of claim 7,
wherein the model includes at least one of an artificial intelligence (AI) model including a recurrent neural network (RNN) model and a long short-term memory model (LSTM), a machine learning (ML) model including the RNN model and the LSTM, and an algorithm model including the RNN model and the LSTM.

9. A first electronic device performing wireless communication, comprising:
a transceiver; and
a controller configured to:
perform a fine timing measurement (FTM) protocol with at least one second electronic device,
obtain a first input value for a signal transmitted or received through the FTM protocol,
determine, using the first input value, whether the at least one signal transmitted to or received from the at least one second electronic device is a line of sight (LOS) signal,
select, from among the at least one second electronic device, at least one third electronic device transmitting to or receiving from the first electronic device the at least one signal determined to be an LOS signal, and
determine a position of the first electronic device using the at least one third electronic device.

10. The first electronic device of claim 9,
wherein the first input value includes at least one of a standard deviation value measured for the FTM, a measured received signal strength indicator (RSSI) value for the FTM, and a distance value measured for the at least one second electronic device.

11. The first electronic device of claim 10, wherein when determining, using the first input value, whether the at least one signal transmitted to or received from the at least one second electronic device is an LOS signal, the controller is further configured to:
determine whether the standard deviation value is less than or equal to a set threshold,
when the standard deviation value is less than or equal to the set threshold, determine that the at least one signal for the at least one second electronic device is an LOS signal, and
when the standard deviation value exceeds the set threshold, determine that the at least one signal for the at least one second electronic device is a non-line of sight (NLOS) signal.

12. The first electronic device of claim 10, wherein when determining, using the first input value, whether the at least one signal transmitted to or received from the at least one second electronic device is an LOS signal, the controller is further configured to:
obtain an estimated RSSI for the at least one signal,
determine whether a difference between the measured RSSI and the estimated RSSI is less than or equal to a threshold,
when the difference is less than or equal to the threshold, determine that the at least one signal for the at least one second electronic device is an LOS signal, and
when the difference exceeds the threshold, determine that the at least one signal for the at least one second electronic device is an NLOS signal.

13. The first electronic device of claim 12,
wherein the estimated RSSI is estimated using a pathloss model.

14. The first electronic device of claim 10, wherein when determining, using the first input value, whether the at least one signal transmitted to or received from the at least one second electronic device is an LOS signal, the controller is further configured to:
obtain an estimated distance value for the at least one signal,
determine whether a difference between the measured distance value and the estimated distance value is less than or equal to a threshold,
when the difference is less than or equal to the threshold, determine that the at least one signal for the at least one second electronic device is an LOS signal, and
when the difference exceeds the threshold, determine that the at least one signal for the at least one second electronic device is an NLOS signal.

15. The first electronic device of claim 9,
wherein when determining, using the first input value, whether the at least one signal transmitted to or received from the at least one second electronic device is an LOS signal, the controller is configured to determine whether the at least one signal transmitted to or received from the at least one second electronic device is an LOS signal using an output value of a model using the first input value as input data, wherein the model is an LOS classification model.

16. The first electronic device of claim 15,
wherein the model includes at least one of an artificial intelligence (AI) model including a recurrent neural network (RNN) model and a long short-term memory model (LSTM), a machine learning (ML) model including the RNN model and the LSTM, and an algorithm model including the RNN model and the LSTM.
